(19) United States
(12) Patent Application Publication
(10) Pub. No.: US 2010/0185935 A1
(43) Pub. Date: Jul. 22, 2010

(54) SYSTEMS AND METHODS FOR COMMUNITY DETECTION

(75) Inventors: Tianbao Yang, East Lansing, MI (US); Shenghuo Zhu, Santa Clara, CA (US); Yun Chi, Santa Clara, CA (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/629,047

(22) Filed: Dec. 2, 2009

Related U.S. Application Data
(60) Provisional application No. 61/145,994, filed on Jan. 21, 2009.

(51) Int. Cl. G06F 15/16; G06F 17/00

(52) U.S. Cl. 715/234; 709/204

(57) ABSTRACT

Systems and methods are disclosed to detect communities of a social network by receiving linked documents from the social network; generating one or more conditional link models and one or more discriminative content models from the linked documents; creating a discriminative model by combining the one or more conditional link models and discriminative content models; and applying the discriminative model to the social networks.

The present application claims priority to U.S. Provisional Application Ser. No. 61/145,994, filed Jan. 21, 2009, the content of which is incorporated by reference.

### BACKGROUND

The present application relates to social network community detection.

As online repositories such as digital libraries and user-generated media such as blogs become more popular, analyzing such networked data has become an increasingly important issue. One major topic in analyzing such networked data is to detect salient communities among individuals. Community detection has many applications such as understanding the social structure of organizations and modeling large-scale networks in Internet services.

A networked data set is usually represented as a graph where the individuals in the network are represented by the nodes in the graph. The nodes are tied with each other by either directed links or undirected links, which represent the relations among the individuals. In addition to the links that they are incident to, nodes are often described by certain attributes known as contents of the nodes. For web pages, online blogs, or scientific papers, the contents are usually represented by histograms of keywords, for example. As another example, in the network of co-authorship, each node corresponds to a different researcher, and the contents of nodes can be the demographic or affiliation information.

Many existing techniques on community detection focus on either link analysis or content analysis. However, neither information alone is satisfactory in determining accurately the community memberships: the link information is usually sparse and noisy and often results in a poor partition of networks; while irrelevant content attributes could significantly mislead the process of community detection. Recently, link analysis and content analysis have been used together for community detection in networks. Most of these approaches adopted a generative framework where a generative model for link and a generative one for content are combined through a set of shared hidden variables. These generative models still have shortcomings in that they failed to isolate factors that are irrelevant to community memberships.

### SUMMARY

In one aspect, systems and methods are disclosed to detect communities of a social network by receiving linked documents from the social network; generating one or more conditional link models and one or more discriminative content models from the linked documents; creating a discriminative model by combining the one or more conditional link models and discriminative content models; and applying the discriminative model to the social networks.

Implementations of the above aspect may include one or more of the following. The system includes a corresponding inference operation which is based on maximizing data. The system generates link features that encode the source, target, direction, and counts of each link; and generates features from the contents of the documents. The system can generate salient communities, influential individuals, and the important topics in the social network, for example.

In one embodiment, the system combines link and content analysis for community detection from networked data, such as data in paper citation networks and data on the Web. The system uses a discriminative model for combining the link and content analysis for community detection. In one embodiment, a conditional model is used for link analysis and in the model, the popularity of a node is explicitly modeled by using a hidden variable. In contrast to generative models, the system does not attempt to generate the links; instead, the conditional probability for the destination of a given link is subsequently captured. To achieve this, the system uses a hidden variable to capture the popularity of a node in terms of how likely the node is cited by other nodes.

In another embodiment, to alleviate the impact of irrelevant content attributes, a discriminative model is additionally used for content analysis. To alleviate the impact of irrelevant content attributes, the system uses a discriminative approach to make use of the node contents (discriminative content model). As a consequence, the attributes are automatically weighed by their discriminative power in terms of telling apart salient communities. These two models are unified seamlessly via the community memberships. The two models are incorporated into a unified framework with a two-stage optimization process for the maximum likelihood inference. The link model and content model can be used to extend existing complementary approaches.

The system can apply the obtained community assignment variables to characterize individual community memberships and to characterize community structures. The obtained reputations are used to capture the top experts and most influential individuals in each community. Alternatively, the system applies the obtained topics and the topic distributions to represent the main topics in each community. The system uses corresponding inference methods based on maximizing the data likelihood. In one embodiment, the system uses the two-step EM optimization method for parameter inference by maximizing data likelihood.

Advantages of the preferred embodiments may include one or more of the following. The system significantly outperforms the state-of-the-art approaches for combining link and content analysis for community detection. The system efficiently solves the related optimization problems based on bound optimization and alternating projection. In addition to using community membership to model links, the system incorporates addition factors such as the popularity of a node (and hence how likely the node receives a link), and the activity level of a node (and hence how likely the node initiates a link). The system also handles irrelevant attributes to improve performance. Additionally, each of the two models can be joined with other existing complementary approaches.

Although each of the two alone benefits existing approaches, when combined together, the conditional link model and the discriminative content model offer the greatest improvement. Compared to other state-of-the-art baseline methods, the system models both links and contents by using discriminative models and then combines the two in a unified framework for extracting communities in social networks. As a result, the system can extract from social networks more accurate communities than other methods in term of obtaining more cohesive community structures and more focused community topics The extracted community structures and community contents provide business values in various application such as providing insights and producing value-added information on long tail data sets in social networks, and helping understand and mine Consumer Generated Media (CGM), such as mining customer-product opinions for customer relationship management (CRM), among others.

### BRIEF DESCRIPTION OF THE DRAWINGS

FIG. 1 shows an exemplary process for analyzing social networks.

FIG. 2 shows in more detail a process for community assignment and reputation determination in FIG. 1.

FIG. 3 shows an exemplary system for extracting communities from linked documents in social networks.

FIG. 4 shows a block diagram of a computer to support the system.

### DESCRIPTION

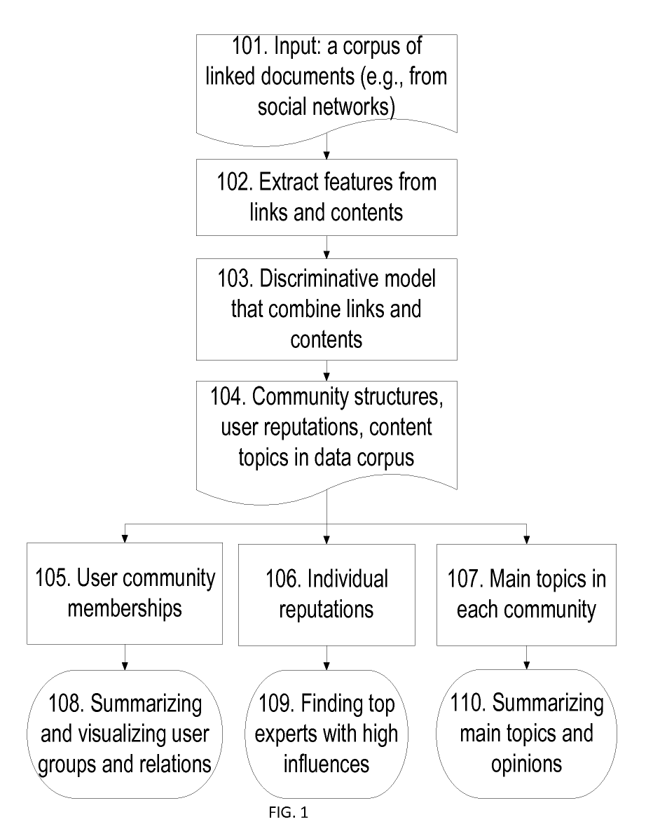

FIG. 1 shows an exemplary process for analyzing social networks. In 101, the process receives as input a corpus of linked documents, which can be obtained from social networks, among others. Next, in 102, the process extract features from the links and contents, where the link features can be the existence, count, and direction of links; the content features can be derived from the content keywords.

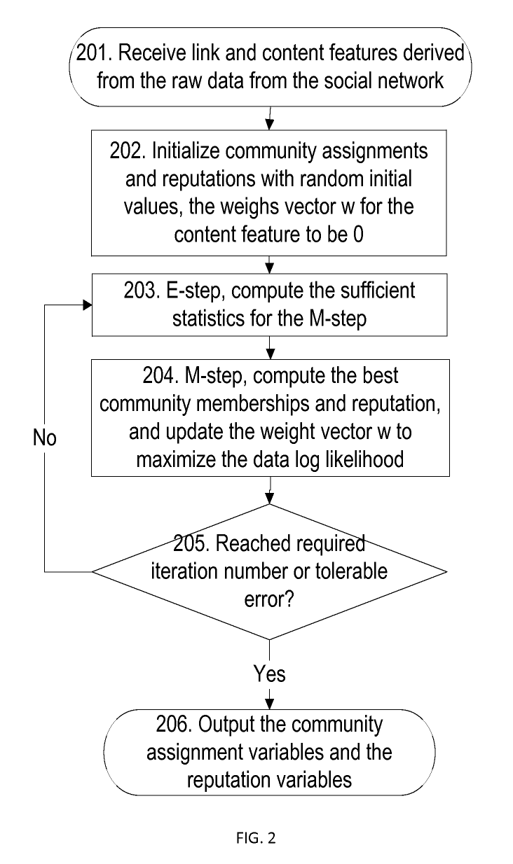

The process then uses a discriminative model for combining link and content information. A conditional model is used which explicitly introduces the variables of reputation when modeling the links among nodes. Additionally, to alleviate the impact of irrelevant content attributes, the system applies a discriminative model for content analysis. The models for link analysis and content analysis are connected via the shared hidden variables of community memberships. In 103, the process applies the discriminative model that combines link and content features, and then applies a parameter inference method as detailed in FIG. 2.

Using the model and the inference method in 103, the process generates essential community structures, user reputations, and content topics in the data corpus in 104. Correspondingly, in 105, the process derives user community memberships by using the results in 104. Additionally, in 106, the process derives top experts and highly influential individuals in the social network by using the results obtained in 104. In 107, the process can derive main topics associated with each community by using the results in 104.

In 108, the process performs summarization and visualization of the user groups and relations using information obtained from 105. In 109, the process identifies top experts or top influencers using information obtained from 106. Correspondingly, in 110, the process generates topic and opinion summarization using information obtained from 107.

The discriminative model used in FIG. 1 for combining link and content information benefits from the following: 1) links are usually decided not only by the communities of individual nodes but also by the other properties of nodes such as reputation and it is insufficient to model links only by the community memberships; and 2) the process removes content attributes (e.g., occurrence of keywords) that can be irrelevant to the community of nodes, and therefore could mislead a model in deciding appropriate community memberships.

FIG. 2 shows in more detail a process for community assignment and reputation determination done in 103 of FIG. 1. First, in 201, the process receives link and content features derived from the raw data from the social network. Next, in 202, the process initializes the community assignments and reputations with random initial values, and initializes a weights vector w for the content features to zero.

In 203, sufficient statistics for operation 204 are computed from the current community assignments and reputations variables. In 204, the process determines the best community memberships and reputation. After that, the process updates the weight vector w to maximize the data log likelihood. The process repeats 204 until the number of required iterations or the tolerable error is reached in 205. The process completes in 206 after generating community assignment variables and reputation variables as the output.

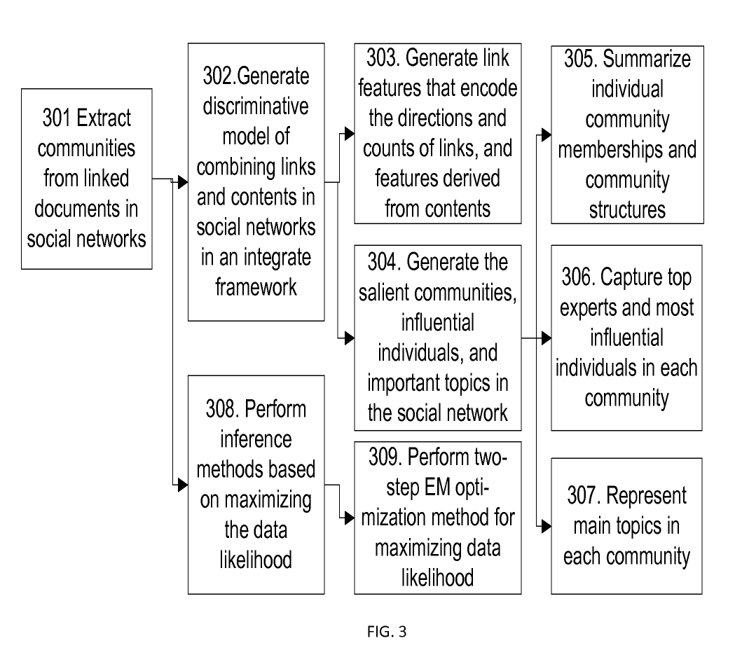

FIG. 3 shows an exemplary system 301 for extracting communities from linked documents in social networks. The system runs a discriminative model that combines links and contents in social networks in an integrated framework in 302. The system also includes a corresponding inference operation which is based on maximizing data likelihood in 308.

In 303, the system generates link features that encode the source, target, direction, and counts of each link; and generates features from the contents of the documents. Then, in 304, the system then generates salient communities, influential individuals, and the important topics in the social network.

Next, in 305, the system applies the obtained community assignment variables to characterize individual community memberships and to characterize community structures. In 306, the obtained reputations are used to capture the top experts and most influential individuals in each community. Additionally, in 307, the system applies the obtained topics and the topic distributions to represent the main topics in each community. In 308, the system uses corresponding inference methods based on maximizing the data likelihood. In one embodiment, in 309, the system uses the two-step EM optimization method for parameter inference by maximizing data likelihood.

Next, one exemplary system for incorporating content via a discriminative model is discussed. In contrast to conventional approaches that combine link and content by a generative model that generates both links and content attributes via a shared set of hidden variables related to community memberships, the system uses a Discriminative Content(DC) model, to incorporate the content into the proposed link model. Let xᵢεR_{d} denote the content vector of node i. The content information is used to model the memberships of nodes by a discriminative model, given by

$$Pr ( {z}_{i} = k ) = \frac{exp ( {a}_{ik} )}{{\sum }_{l} exp ( {a}_{il} )}$$

where aᵢ is a K-dimensional vector with each element aᵢₖ=wₖ^{T}φ(xᵢ), wₖεR^{d}, and φ(xᵢ) is the transformed content vector for node i. The conditional link probability Pr(j|i) is modified as follows

$$Pr ( j \vert i ; b , w ) = {\sum }_{k} {y}_{ik} \frac{{y}_{jk} {b}_{j}}{{\sum }_{{j}^{′} ∈ LO ( i )} {y}_{{j}^{′} k} {b}_{{j}^{′}}}$$

$$where$$

$${y}_{ik} = \frac{exp ( {a}_{ik} )}{{\sum }_{l} exp ( {a}_{il} )}$$

Content attributes are not generated, but by using the discriminative model, with an appropriately chosen weight vector wₖ that assign large weights to important attributes and small weights or zero weights to irrelevant attributes, we avoid the shortcoming of the generative models, i.e., being misled by irrelevant attributes. In the combined model, the log-likelihood can be written as

$$log L = {\sum }_{( i \to j ) ∈ E} {\hat{s}}_{ij} log {\sum }_{k} {y}_{ik} \frac{{y}_{jk} {b}_{j}}{{\sum }_{{j}^{′} ∈ LO ( i )} {y}_{{j}^{′} k} {b}_{{j}^{′}}}$$

The system maximizes the log-likelihood over the free parameters w and b.

Although any gradient-based methods can be used to optimize with wₖ and bᵢ, an efficient two-stage method is used in one embodiment to map the relationship of link model and content model. The embodiment uses the EM algorithm to maximize the log-likelihood. In the E-step, the compute τᵢₖ and qᵢⱼₖ from y and b. In the M-step, the system maximizes the following problem:

$${max}_{w , b} {\sum }_{( i \to j ) ∈ E} {\hat{s}}_{ij} {\sum }_{k} {q}_{ijk} ( log {y}_{ik} + log {y}_{jk} + log {b}_{j} - {\sum }_{{j}^{′} ∈ LO ( i )} \frac{{y}_{{j}^{′} k} {b}_{{j}^{′}}}{{τ}_{ik}} )$$

where yᵢₖ depends on w.

Instead of maximizing over w, the above equation is converted into a constraint optimization problem over y and b by

$${max}_{y ∈ Δ , b} {\sum }_{( i \to j ) ∈ E} {\hat{s}}_{ij} {\sum }_{k} {q}_{ijk} ( log {y}_{ik} + log {y}_{jk} + log {b}_{j} - {\sum }_{{j}^{′} ∈ LO ( i )} \frac{{y}_{{j}^{′} k} {b}_{{j}^{′}}}{{τ}_{ik}} )$$

where the domain Δ is defined as

$$Δ = \{ y \vert ∃ w , {y}_{ik} = \frac{exp ( {w}_{k}^{T} φ ( {x}_{i} ) )}{{\sum }_{l} exp ( {w}_{l}^{T} φ ( {x}_{i} ) )} \}$$

A projection method is used to maximize the above problem, which leads to the two-stage method. In the first stage, the system solves the optimization problem as if both y and b are free variables. In the second stage, the system projects the yᵢₖ into the domain Δ. If \tilde{y}ᵢₖ denote the optimal solution obtained from the first stage, the projection of \tilde{y}ᵢₖ, denoted by yᵢₖ, is obtained by minimizing the KL divergence between \tilde{y}ᵢₖ and yᵢₖεΔ, which is equal to the following optimization problem

$${max}_{w} {\sum }_{i} {\sum }_{k} {\tilde{y}}_{ik} log {y}_{ik} = {\sum }_{i} {\sum }_{k} {\tilde{y}}_{ik} log \frac{exp ( {w}_{l}^{T} φ ( {x}_{i} ) )}{{\sum }_{l} exp ( {w}_{l}^{T} φ ( {x}_{i} ) )} .$$

This problem is similar to the log-likelihood in multi-class logistic regression problem except that the class membership \tilde{y}ᵢₖ is not just binary but between 0 and 1. As in logistic regression, a regularization term can be added on wₖ to make the solution more robust, which leads to the following optimization problem

$${max}_{w} {\sum }_{i} {\sum }_{k} {\tilde{y}}_{ik} log \frac{exp ( {w}_{k}^{T} φ ( {x}_{i} ) )}{{\sum }_{l} exp ( {w}_{l}^{T} φ ( {x}_{i} ) )} - \frac{λ}{2} {\sum }_{k} {w}_{k}^{T} {w}_{k}$$

where λ is the regularization coefficient. This problem is a convex problem and has a unique optimal solution, and can be maximized efficiently by Newton's method.

In the framework for combined link model and content model, the link structure will first provide a noisy estimation of community memberships \tilde{y}, and the noisy memberships are then used as supervised information for the discriminative content model to derive high-quality memberships y. These estimated memberships are further used in the EM iterations.

One exemplary method for maximizing the log-likelihood is as follows:
1. Input the number of iterations or convergence rate
2. Initialize wₖ to zeros, bᵢ randomly, λ to a fixed value
3. in the E-step, compute τᵢₖ and qᵢⱼₖ using yᵢₖ rather than γᵢₖ
4. in the M-step,
   compute γᵢₖ, and bᵢ
   compute wₖ by maximizing the objective with γᵢₖ in place of ŷᵢₖ, and then compute yᵢₖ
5. repeat step 6 and 6 until the input number of iterations is exceeded or convergence rate is satisfied.
6. output γᵢₖ or yᵢₖ as the final membership

The method has a time complexity of O(N(eKC₁+nKC₂+C₃)), where N is the number of iterations, e is the number of links in the network, n is the number of nodes in the network, C₁ is a constant factor in computing qᵢⱼₖ and τᵢₖ, C₂ is a constant factor in computing γᵢₖ and bᵢ, and C₃ is the constant time for maximizing problem by Newton's method.

In one embodiment, the system combines link and content analysis for community detection from networked data, such as data in paper citation networks and data on the Web. The system uses a discriminative model for combining the link and content analysis for community detection. In one embodiment, a conditional model is used for link analysis and in the model, the popularity of a node is explicitly modeled by using a hidden variable. In contrast to generative models, the system does not attempt to generate the links; instead, the conditional probability for the destination of a given link is subsequently captured. To achieve this, the system uses a hidden variable to capture the popularity of a node in terms of how likely the node is cited by other nodes.

In another embodiment, to alleviate the impact of irrelevant content attributes, a discriminative model is additionally used for content analysis. To alleviate the impact of irrelevant content attributes, the system uses a discriminative approach to make use of the node contents (discriminative content model). As a consequence, the attributes are automatically weighed by their discriminative power in terms of telling apart salient communities. These two models are unified seamlessly via the community memberships. The two models are incorporated into a unified framework with a two-stage optimization process for the maximum likelihood inference. The link model and content model can be used to extend existing complementary approaches.

In sum, the system uses a unified model to combine link and content analysis for community detection. To accurately model the link patterns, a conditional link model captures the popularity of nodes. In order to alleviate the problem caused by the irrelevant attributes, a discriminative model, instead of a generative model, is used for modeling the content of nodes. The link model and content model is combined via a probabilistic framework through the shared variables of community memberships. The combined model obtains significant improvement over the state-of-the-art approaches for community detection. In another embodiment, a full Bayesian model can also be used to compute the posterior of membership and parameters rather than computing the maximum likelihood estimation.

The system may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

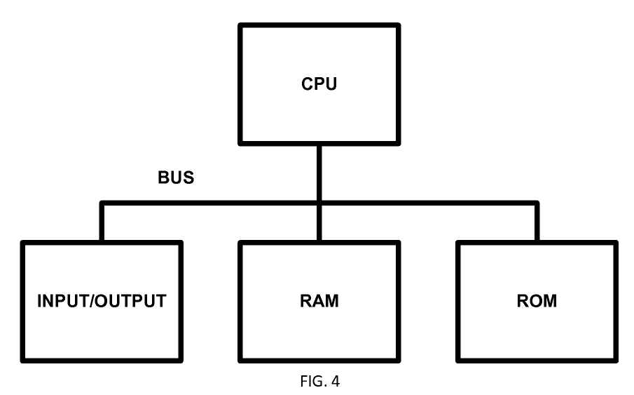

By way of example, FIG. 4 shows a block diagram of a computer to support the system. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

What is claimed is:

1. A method to detect communities of a social network, comprising
a. receiving linked documents from the social network;
b. generating one or more conditional link models and one or more discriminative content models from the linked documents;
c. creating a discriminative model by combining the one or more conditional link models and discriminative content models; and
d. applying the discriminative model to the social networks.

2. The method of claim 1, comprising extracting features from the links and contents in the documents.

3. The method of claim 1, comprising generating a community structure, a user reputation, or a content topic using the discriminative model.

4. The method of claim 1, comprising generating a community structure and assigning a user as a member of a predetermined community.

5. The method of claim 1, comprising generating a user reputation for each user and selecting one or more users with high community influence.

6. The method of claim 1, comprising determining one or more main topics in each community and summarizing the topics.

7. The method of claim 6, comprising summarizing opinions in the community for a predetermined topic.

8. The method of claim 1, comprising performing a two-step EM optimization for parameter inference by maximizing data likelihood.

9. The method of claim 8, comprising determining sufficient statistics in the E-step.

10. The method of claim 9, comprising determining best community memberships and reputation in the M-step.

11. The method of claim 9, comprising
in the E-step, determining τᵢₖ and qᵢⱼₖ from y and b; and
in the M-step, maximizing
$${max}_{w , b} {\sum }_{( i \to j ) ∈ E} {\hat{s}}_{ij} {\sum }_{k} {q}_{ijk} ( log {y}_{ik} + log {y}_{jk} + log {b}_{j} - {\sum }_{{j}^{′} ∈ LO ( i )} \frac{{y}_{{j}^{′} k} {b}_{{j}^{′}}}{{τ}_{ik}} )$$
where yᵢₖ depends on w.

12. The method of claim 1, comprising updating a weight vector to maximize data log likelihood.

13. The method of claim 1, comprising
a. generating link features that encode the source, target, direction, and counts of each link; and
b. generating features from document contents.

14. The method of claim 1, comprising determining salient communities, influential individuals, or important topics in the social network.

15. A system to detect communities in a social network, comprising:
a. means for receiving linked documents from the social network;
b. means for generating one or more conditional link models and one or more discriminative content models from the linked documents;
c. means for creating a discriminative model by combining the one or more conditional link models and discriminative content models; and
d. means for applying the discriminative model to the social networks.

16. The system of claim 15, comprising means for characterizing individual community membership or community structure.

17. The system of claim 15, comprising means for detecting experts or influential individuals in each community.

18. The system of claim 15, comprising means for applying obtained topics and topic distributions to represent the main topics in each community.

19. The system of claim 15, comprising means for updating a weight vector to maximize data log likelihood.

20. The system of claim 15, comprising
a. means for generating link features that encode the source, target, direction, and counts of each link; and
b. means for generating features from document contents.
